(19) United States
(12) Patent Application Publication
(10) Pub. No.: US 2005/0110224 A1
(43) Pub. Date: May 26, 2005

(54) Centering mandrel for turning wheels

(76) Inventor: William E. Launius JR., Millstadt, IL (US)

Correspondence Address: CHARLES C. MCCLOSKEY, 763 S. NEW BALLAS ROAD STE. 170, ST. LOUIS, MO, 63141, US

(21) Appl. No.: 10/960,230

(22) Filed: Oct. 7, 2004

Related U.S. Application Data
(60) Provisional application No. 60/524,658, filed on Nov. 25, 2003.

(51) Int. Cl. B23B 31/00

(52) U.S. Cl. 279/8

(57) ABSTRACT

The present invention centers a hub of a wheel upon a mandrel so the wheel rotates about an axis precisely perpendicular to the plane of the wheel. The centering mandrel has a body, and a rod secured to the body. The cylindrical body has a shaft for connection to a rotating chuck. Opposite the shaft, the body receives the rod in a threaded cylinder. The cylindrical rod has threads to engage the cylinder and has a knob for manual turning. In operation, a child places a wheel upon the cylinder, inserts the rod through the hub, and turns the knob to secure the wheel. Then a parent places the shaft into a chuck for turning the wheel and truing using hand tools.

### CROSS REFERENCE TO RELATED APPLICATION

This non-provisional patent application claims priority to the provisional application for patent having Ser. No. 60/524,658 and filed on Nov. 25, 2003.

### BACKGROUND OF THE INVENTION

This invention relates to hand tools in general and more specifically to a tool that centers wheels on mandrels for finishing. As winter loosens its grip, children emerge from homes across the land for contests such as the “Pinewood Derby.”

For the derby, children and their adult sponsors assemble a wooden car from a kit and then race their cars against those of fellow children upon a track. Children that win local races advance to tournaments. As a car race, speed remains essential to victory. Children and sponsors seek to minimize wheel friction and align wheels precisely to the track at each opportunity.

The wooden cars have four wheels: plastic with a finished face, a rim, and a centered hub opposite the finished face. The finished face has a stylized appearance of a spoked wheel. The spokes bypass the center of the finished face which has a cylindrical depression in the surface of the face. The hub fits over an axle hammered into the car. Spinning upon the axle, the rim contacts the track. An out of round rim produces a wobbly wheel and a wayward car that loses seconds and races.

### DESCRIPTION OF THE PRIOR ART

Sponsors and children have participated in Pinewood Derby races for years. Sponsors supervise and assist children in shaping a car body and assembling the wheels. Children carve, paint, and weight their car bodies for speed and to suit their personalities. Assembly of the cars has remained little changed. With the car body shaped and painted, children place axles through wheels and then hammer the axles into specified locations on the car body, shown by kerfs. Designated sponsors then operate the raceways where the children race their cars, typically in the winter.

Prior art designs placed a threaded shaft through the hub and into the body of a mandrel. A sponsor would install the mandrel in a lathe, place a threaded shaft through the hub, secure the wheel behind a head upon the shaft by turning the head with a screwdriver, rotate the wheel, and apply a tool to finish the rim as round. Because of lathe tools, children had less participation in fine-tuning their cars and slower cars. With variations in hub diameter and a loose friction connection between the head and the wheel, wheels would rotate out of round. In summary, prior art requires a lathe handled by sponsors and wheels tightly fitted to the mandrel while children sat out the fine-tuning of their cars.

Instances of mandrels used in model cars, particularly Pinewood Derby cars, are few. Some mandrels have appeared in the prior art though removed from model cars. The patent to Strand, No. 4,571,129, shows a mandrel assembly of two mandrels joined by an air pressure collet. The mandrels have a bar passing through the center, where the present invention has a threaded rod to secure a wheel to the end of a shaft.

The patent to Minelli, No. 4,899,458 has a mandrel centered by electronically controlled drives. The drives displace a pilot shaft upon two axes under electronic measurement. The apparatus then moves the pilot shaft to the center, determined electronically, for service as a mandrel for a valve guide of a valve seat for machining. In contrast, the present invention lacks electronics and centers a wheel upon the mandrel, not the mandrel itself.

The patent to Landgraf, No. 5,211,907 centers a pin in a nuclear reactor core, a completely different field than the present invention. The present art overcomes the limitations of the prior art. That is, the art of the present invention allows children to center their wheels for finishing. The present art further allows a more precise alignment of a wheel with the track.

The difficulty in providing centered wheels by children is shown by the operation of a typical device. From the factory, wheels have burrs and imperfections in the rim. A parent, or sponsor, places a mandrel in a lathe, drill press or hand drill. The sponsor then positions a threaded shaft through the hub of a wheel. Turning the threaded shaft, the sponsor secures the wheel to the mandrel. The threaded shaft has a slotted head for a screwdriver to tighten firmly. Friction between the slotted head and the wheel holds the wheel upon the mandrel. The sponsor then turns the lathe, the mandrel, and the wheel. Sandpaper or tools applied to the rim then round the wheel. While turning, the wheel may rotate upon the shaft causing the wheel to remain out of round. Differences in diameter between the threaded shaft and the hub may also cause an out of round wheel. A non-centering shaft may not accurately position the wheel for precise rounding of the rim. The present invention overcomes this difficulty.

### SUMMARY OF THE INVENTION

A unique aspect of the present invention is centering the hub upon a mandrel. Centering the hub allows a wheel to rotate about an axis precisely perpendicular to the plane of the wheel. The present invention has two main pieces: a body, and a rod that secures to the body. The body is generally cylindrical and has a shaft for connection to a lathe, or drill chuck. Opposite the shaft, the body has a threaded cylinder to receive the rod. The rod has a generally cylindrical shape with a free end. Opposite the free end, a cone joins to the rod and a knob joins to the cone. In operation, a child places a wheel upon the cylinder, depression first, then inserts the rod through the hub and into the cylinder. After turning the knob to secure the wheel to the mandrel, a sponsor places the shaft into a chuck for turning the wheel and truing using hand tools.

There has thus been outlined, rather broadly, the more important features of the invention in order that the detailed description thereof that follows may be better understood and that the present contribution to the art may be better appreciated. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

It is therefore an object of the present invention to provide a new and improved centering mandrel that has all of the advantages of the prior art mandrels and none of the disadvantages.

It is another object of the present invention to provide a new and improved centering mandrel that may be easily and efficiently manufactured and marketed.

An even further object of the present invention is to provide a new and improved centering mandrel that has a low cost of manufacture with regard to both materials and labor, and which accordingly then has low prices enticing to the consuming public, thereby making such a centering mandrel economically available to children and their sponsors.

Still another object of the present invention is to provide a centering mandrel for truing wheels. This rounds wheels in a precise circular shape and with a flat rim. A round wheel with a flat rim rides flat upon the track without a wobble. The trued and flat wheel allows a model car to roll straight at increased speed.

Still yet another object of the present invention is to provide a centering mandrel for truing wheels. This makes it possible for a child to finish a wheel under adult supervision.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 shows an oblique view of the preferred embodiment of the rod of the centering mandrel constructed in accordance with the principles of the present invention;

FIG. 2 shows an oblique view of the preferred embodiment of the body and the rod of the centering mandrel constructed in accordance with the principles of the present invention;

FIG. 3 shows a wheel with a stepped flange, or depression, for reverse mounting upon the body of the mandrel constructed in accordance with the principles of the present invention; and,

FIG. 4 shows an exploded view of a wheel installed between the body and the rod of the centering mandrel tool constructed in accordance with the principles of the present invention.

The same reference numerals refer to the same parts throughout the various figures.

### DESCRIPTION OF THE PREFERRED EMBODIMENT

The present invention overcomes the prior art limitations by centering a wheel and accepting a reverse mount of the wheel. In FIG. 1, the centering mandrel 1 begins with a threaded rod 3, generally cylindrical in shape, with a free or first end 4 and an opposite second end 5. The second end 5 joins the apex of a truncated cone 4a. The base of the cone 4a has a wider diameter than the threaded rod 3 but less than the diameter of a hub of a wheel 2. The base of the cone 4a then attaches to a cylindrical knob 9. The knob 9 is knurled to ease manual turning and has a diameter greater than the hub in the preferred embodiment.

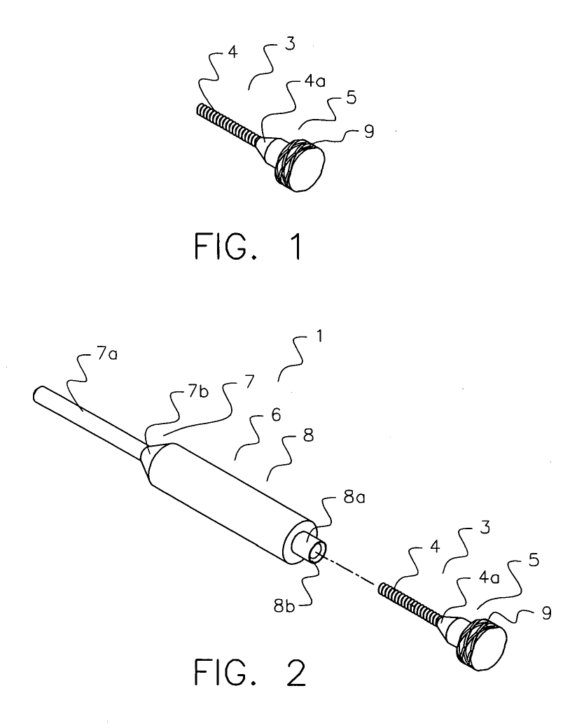

In addition to the rod 3, the centering mandrel 1 has a body 6 shown in FIG. 2. The body 6 has a generally round cylindrical shape, a first end 7, and an opposite second end 8. The first end 7 has a conical portion 7b of the body 6 extending into a cylindrical shaft 7a of a diameter less than that of the body 6. The shaft 7a has sufficient length for a tight fit into a lathe, or drill chuck. Opposite the first end 7, the second end 8 has a cylinder 8a of slightly less than the diameter of the body 6 and a length less than three cylinder 8a diameters. The cylinder 8a has a centered threaded hole 8b to accept the first end 4 of the rod 3.

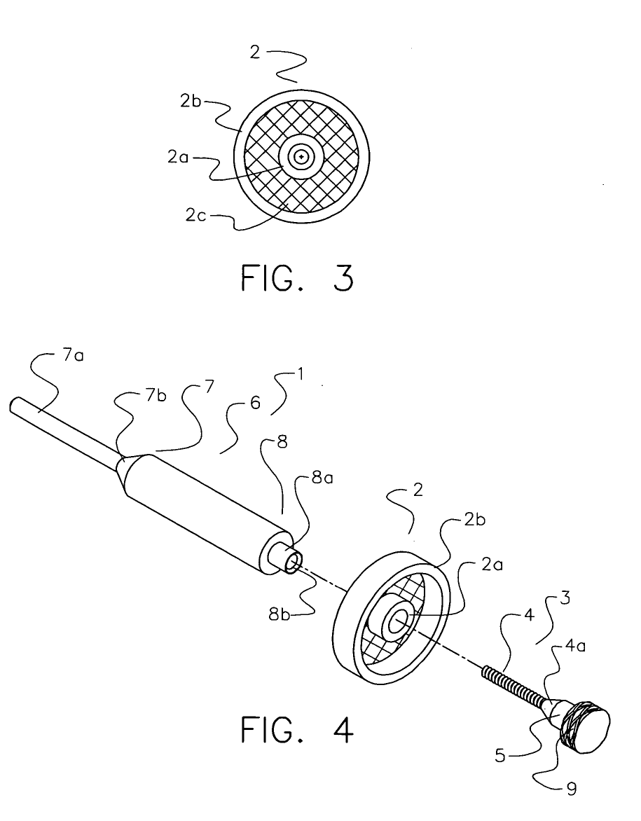

Turning to FIG. 3, a wheel 2 has a circumferential rim 2b with an interior planar section 2c for rigidity located on one edge of the rim 2b. The planar section 2c of the wheel 2 has a stepped flange, or depression 2a, with a thinner section coaxial with the hub. The cylinder 8a diameter matches that of the depression 2a in the planar section 2c of a wheel 2 so the cylinder 8a fits snugly. Wheels 2 come in sets of four for a car body kit.

And in FIG. 4, a centering mandrel 1 assembles for use. The wheel 2 is placed with the depression 2a upon the cylinder 8a and the hub away from the second end 8 of the body 6. The first end 4 of the threaded rod 3 enters the hub, advances into the cylinder 8a, and secures the wheel 2 to the body 6. Tightening of the rod 3 in the cylinder 8a seats the wheel 2 for machining. The cylinder 8a fits snugly in the depression 2a, a reverse mount of the wheel 2, and the cone 4a centers the wheel 2 upon the rod 3 in particular and the centering mandrel 1 in general. Alternatively, wheel 2 is placed with the hub towards the cylinder 8a in a forward mount. The cone 4a, advanced into the depression 2a and through the hub into the cylinder 8a, centers the forward mounted wheel 2. The cone 4a upon the depression 2a prevents the wheel 2 from wobbling as the mandrel 1 rotates and leads to a round and true wheel 2.

Typically, the centering mandrel 1 operates in many environments such as a basement workshop, a garage, trackside, and the like. To utilize the present art 1, a child grasps the body 6 of the mandrel in one hand. Referring to FIG. 4, placing a wheel 2 with the depression 2a towards the cylinder 8a, the child then inserts the threaded rod 3 through the hub. Turning the knob 9, the child advances the cone 4a partially into the hub. The cone 4a engages the interior circumference of the hub and centers the hub and hence the wheel 2. The child turns the knob 9 until the wheel 2 is snug to the cylinder 8a.

Then the child inserts the shaft 7a into a chuck of a lathe, or a drill, for a sponsor to operate. Turning the shaft 7a rotates the wheel 2 for finishing of the rim 2b by sandpaper or tools. After a few turns, the child has a true and round wheel 2 with a smooth rim 2b. In a second operation, the mandrel 1 rotates and a child applies sandpaper or a tool to the interior circumference of the rim 2b. After a few turns of the wheel 2, the child has removed some weight of the wheel 2 to accelerate rotation of the wheel 2 and thus to raise the velocity of the car. Children and sponsors must wear safety equipment and exercise sound judgment to deter injury and to avoid removing too much material lest the rim 2b collapse.

The preferred embodiment uses zinc plated steel and round cross sections perpendicular to the longitudinal axis of the invention for the rod, shaft, body, cone, and knob. From the aforementioned description, a centering mandrel has been described. The centering mandrel is uniquely capable of centering a wheel for finishing. The centering mandrel may be manufactured from many materials including, but not limited to, ferrous and non-ferrous metals and their alloys, plastics, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

1. A device that mounts wheels of model cars for turning upon a lathe or drill chuck, comprising:
a threaded rod, generally cylindrical, having a first end and an opposite second end; and,
a body, generally cylindrical of greater diameter than said threaded rod having a first end and an opposite second end;
whereby a person places said threaded rod through the hub of a wheel, then the first end of said threaded rod into the second end of said body, and the first end of said body into a chuck to rotate said device.

2. The device of claim 1 further comprising:
said first end of said rod having a generally cylindrical shape with threads, a truncated cone flaring out from said rod towards the second end of said rod, and a knob, generally cylindrical in shape of greater diameter than said cone and said rod;
said first end of said body having a shaft of generally cylindrical shape, a truncated cone flaring out from said shaft towards the second end of said body;
said body having a greater diameter than said shaft; and,
said second end of said body having a cylinder of lesser diameter than said body, said cylinder having a centered threaded axial hole to receive the first end of said rod.

3. The device of claim 2 wherein said knob has a knurled finish.

4. The device of claim 2 wherein said cylinder is placed against the center of the wheel and said truncated cone of said rod is placed against the hub of the wheel.

5. The device of claim 2 wherein said cylinder is placed against the hub of the wheel and said truncated cone of said rod is placed against the center of the wheel.

6. A mandrel for rotating a wheel of a model car for machining upon a rotating chuck, the wheel having a centered hub and a rim upon the circumference, comprising:
a body, generally cylindrical having a first end and an opposite second end; and,
a threaded rod, generally cylindrical, having lesser diameter than said body, a first end and an opposite second end;
whereby a person places said threaded rod through the hub of a wheel, then the first end of said threaded rod into the second end of said body, and the first end of said body into the chuck.

7. The device of claim 6 further comprising:
said body having a shaft of generally cylindrical shape for said first end, an increasing diameter of said body towards said second end, and a cylinder of lesser diameter than said body for said second end having a centered threaded axial hole therein; and,
said rod having a generally cylindrical shape with threads for said first end, an increasing diameter of said rod towards said second end, and a knob upon said second end, generally cylindrical of greater diameter than said rod and said second end.

8. The device of claim 7 wherein said knob has a knurled finish.

9. The device of claim 7 wherein said cylinder is placed against the center of the wheel and said truncated cone of said rod is placed against the hub of the wheel.

10. The device of claim 7 wherein said cylinder is placed against the hub of the wheel and said truncated cone of said rod is placed against the center of the wheel.
